(19) United States
(12) Patent Application Publication
(10) Pub. No.: US 2008/0281573 A1
(43) Pub. Date: Nov. 13, 2008

(54) Digital design ecosystem

(76) Inventors: Paul Eric Seletsky, Short Hills, NJ (US); Carl Galioto, Douglaston, NY (US)

Correspondence Address: SUN MICROSYSTEMS;C/O SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/803,099

(22) Filed: May 11, 2007

(51) Int. Cl. G06F 17/50

(52) U.S. Cl. 703/17

(57) ABSTRACT

Methods, systems, and articles of manufacture consistent with the present invention provide a digital design environment in which model information is delivered to a plurality of analysis programs that simultaneously provide real-time feedback to the user and to each other. An administrator/orchestrator program obtains a building information model and outputs a copy of at least a part of the building information model to at least two of the analysis programs. The administrator/orchestrator program receives an analysis result, which is based on an analysis of the copy of the at least part of the building information model, from each of the at least two analysis programs. The at least two analysis programs perform a respective analysis simultaneously to each other. At least two of the received analysis results are simultaneously displayed, such that effects in the received analysis results are simultaneously displayed in real-time responsive to changes in the building model.

### FIELD OF THE INVENTION

The present invention relates to architectural design modeling, and in particular, relates to modeling with real-time simultaneous feedback from a plurality of simulation programs.

### BACKGROUND OF THE INVENTION

As architects and engineers continue to embrace technological advances in computer-aided design via parametric and building-information-modeling processes, the use of automated building analysis programs has been gaining popularity. For example, Parametric and Building Information Modeling (BIM) programs tie physical and informational characteristics to components of a building design, thereby creating a building model with relational physical properties, instead of just a building schematic or a 3D model as an assembly of connected lines. For example, the building information model for a house may tie a material type and cost to each component of the house, keep track of the three-dimensional relationships of the various components, and identify behavioral aspects of the components. The building information model can be fed into a simulation or analysis program to determine the building's behavioral patterns. For example, a building information model may be analyzed to determine how sunlight will illuminate the building throughout a day or to simulate energy consumption, or simulate radiant heat (thermal) loss or gain through a given assembly of wall materials comprised of actual, codified, conductance and resistance values.

To analyze a model using conventional methods, the designer prepares the model using a modeling program, converts the model into a common file format (e.g., IGES, STEP, IFC or DXF), and then imports the converted model into a separate simulation program. If the designer wants to pass the model through other simulation programs, then the designer must repeat the process—sequentially—for the other simulation programs. After all of these sequential simulations have been completed, the designer may then analyze the individual results from the various simulation programs to determine how the model may need to be modified to achieve a known objective. If any changes are implemented, this entire process is repeated by passing the modified model through the various sequential simulations.

The conventional approach has a disadvantage of siloing the design geometry tied to a specific set of performative analysis results without the ability to determine whether those results impact or affect an adjacent set of performative results. For example, the placement of a skylight in a roof might enhance the lighting calculations of rooms into which the skylight admits daylight but adversely impact thermal air heating or cooling loads and, hence, lifecycle energy costs. Further, conventional methods perform multiple simulations serially and after the model has been created. Thus, there is no real-time feedback from the simulation programs to the designer during the design process, nor communication between the simulation programs.

### SUMMARY OF THE INVENTION

Methods, systems, and articles of manufacture consistent with the present invention provide a digital design environment in which model information is delivered to a plurality of analysis programs that simultaneously provide real-time feedback to the user and to each other. Conventional systems perform analyses serially and after a model has been created. Thus, there is no real-time feedback from the analysis programs to the designer during the design process, nor communication between the analysis programs. To overcome these problems of conventional systems, an administrator/orchestrator program consistent with the present invention simultaneously sends model information to a plurality of analysis programs and displays the analysis programs' results in real-time. Further, the administrator/orchestrator program enables communication of information between the analysis programs, allowing the various analyses to change and react to each other.

The administrator/orchestrator program may be used with existing model design programs and analysis programs. An architect using the system works in a traditional manner, using known design geometry modeling software as displayed via a computer screen. The administrator/orchestrator program feeds the model information to the analysis programs, which output performance-oriented information, such as energy usage, solar penetration, material costs, thermal heating and cooling loads, and the like. The administrator/orchestrator program receives this feedback from the various analysis programs, and, in real-time, simultaneously displays the various analysis results to the user. Thus, the user sees a variety of feedback in real-time, while the use manipulates the model, similar to a driver viewing a car's dashboard system or a doctor monitoring a patient's vital signs.

In accordance with methods consistent with the present invention, a method in a data processing system having an administrator/orchestrator program and a plurality of analysis programs is provided. The method comprises the steps performed by the administrator/orchestrator program of: obtaining a building information model; outputting a copy of at least a part of the building information model to at least two of the analysis programs; receiving an analysis result, which is based on an analysis of the copy of the at least part of the building information model, from each of the at least two analysis programs, the at least two analysis programs performing a respective analysis simultaneously to each other; and simultaneously displaying at least two of the received analysis results, such that effects in the received analysis results are simultaneously displayed in real-time, responsive to changes in the building model.

In accordance with articles of manufacture consistent with the present invention, a computer-readable storage medium containing instructions that cause an administrator/orchestrator program, in a data processing system having the administrator/orchestrator program and a plurality of analysis programs, to perform a method is provided. The method comprising the steps of: obtaining a building information model; outputting a copy of at least a part of the building information model to at least two of the analysis programs; receiving an analysis result, which is based on an analysis of the copy of the at least part of the building information model, from each of the at least two analysis programs, the at least two analysis programs performing a respective analysis simultaneously to each other; and simultaneously displaying at least two of the received analysis results, such that effects in the received analysis results are simultaneously displayed in real-time responsive to changes in the building model.

In accordance with systems consistent with the present invention, a data processing system is provided. The data processing system comprises a memory comprising an administrator/orchestrator program that obtains a building information model, outputs a copy of at least a part of the building information model to at least two of a plurality of analysis programs, receives an analysis result, which is based on an analysis of the copy of the at least part of the building information model, from each of the at least two analysis programs, the at least two analysis programs performing a respective analysis simultaneously to each other, and simultaneously displays at least two of the received analysis results, such that effects in the received analysis results are simultaneously displayed in real-time responsive to changes in the building model. A processing unit runs the administrator/orchestrator program.

In accordance with systems consistent with the present invention, a data processing system is provided that comprises means for obtaining a building information model; means for outputting a copy of at least a part of the building information model to at least two of a plurality of analysis programs; means for receiving an analysis result, which is based on an analysis of the copy of the at least part of the building information model, from each of the at least two analysis programs, the at least two analysis programs performing a respective analysis simultaneously to each other; and means for simultaneously displaying at least two of the received analysis results, such that effects in the received analysis results are simultaneously displayed in real-time responsive to changes in the building model.

Other systems, methods, features, and advantages of the invention will become apparent to one with skill in the art upon examination of the following figures and detailed description. It is intended that all such additional systems, methods, features, and advantages be included within this description, be within the scope of the invention, and be protected by the accompanying drawings.

### BRIEF DESCRIPTION OF THE DRAWINGS

The accompanying drawings, which are incorporated in and constitute a part of this specification, illustrate an implementation of the invention and, together with the description, serve to explain the advantages and principles of the invention. In the drawings,

FIG. 1 depicts a block diagram of a data processing system consistent with the present invention;

FIG. 2 depicts a block diagram of computer 102;

FIG. 3 depicts a block diagram of computer 104;

FIG. 4 illustrates the relationship between the data processing system and various users;

FIG. 5 is a flow diagram illustrating steps performed by the administrator/orchestrator program;

FIG. 6 is an illustrative screen shot presented by the administrator/orchestrator program for simultaneously displaying a plurality of analysis results; and

FIG. 7 illustrates the relationship between the data processing system and various users.

### DETAILED DESCRIPTION OF THE INVENTION

Reference will now be made in detail to an implementation consistent with the present invention as illustrated in the accompanying drawings. Wherever possible, the same reference numbers will be used throughout the drawings and the following description to refer to the same or like parts.

Methods, systems, and articles of manufacture consistent with the present invention provide a digital design environment in which model information is delivered to a plurality of analysis programs that simultaneously provide real-time feedback to the user, while the user manipulates the model. An administrator/orchestrator program feeds the building information model information to analysis programs, which output performance-oriented information, such as energy usage, solar penetration, material costs, thermal heating and cooling loads, and the like. The administrator/orchestrator program receives this feedback from the various analysis programs and, in real-time, displays the feedback to the user as the user manipulates the model.

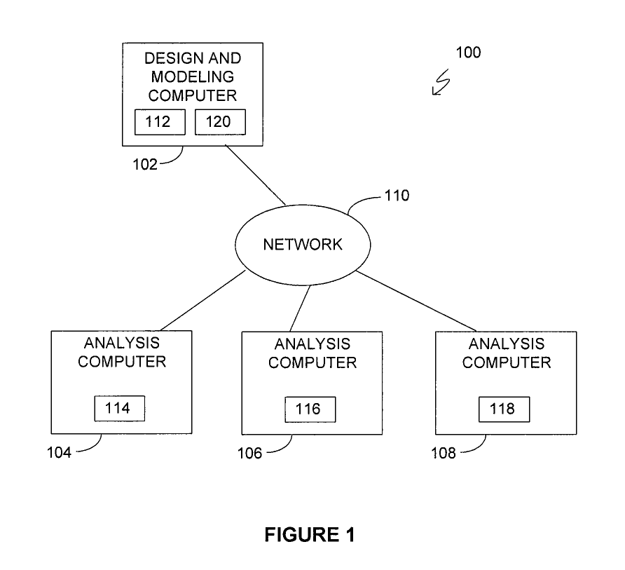

FIG. 1 depicts a block diagram of a data processing system or digital design ecosystem 100 suitable for use with methods and systems consistent with the present invention. Data processing system 100 comprises a plurality of computers 102, 104, 106, and 108 connected via a network 110. The network is of a type that is suitable for connecting the computers for communication, such as a circuit-switched network or a packet-switched network. Also, the network may include a number of different networks, such as a local area network, a wide area network such as the Internet, telephone networks including telephone networks with dedicated communication links, connection-less networks, and wireless networks. In the illustrative example shown in FIG. 1, the network is the Internet. Each of the computers shown in FIG. 1 is connected to the network via a suitable communication link, such as a dedicated communication line or a wireless communication link.

In the illustrative example, computer 102 is a digital design and modeling workstation at which an architect may prepare a building design and building information model using a design and modeling program 112. Computers 104, 106, and 108 are remote workstations that each execute one or more building model analysis programs 114, 116, and 118. As will be described in more detail below, computer 102 also includes an administrator/orchestrator program 120 that transfers building model information to the analysis programs and receives analysis feedback from the analysis programs. The number of computers and the network configuration shown in FIG. 1 are merely an illustrative example. One having skill in the art will appreciate that the data processing system may include a different number of computers and networks. For example, computer 102 may include the building design and modeling program as well as one or more of the analysis programs. Further, the administrator/orchestrator program may reside on a different computer than computer 102.

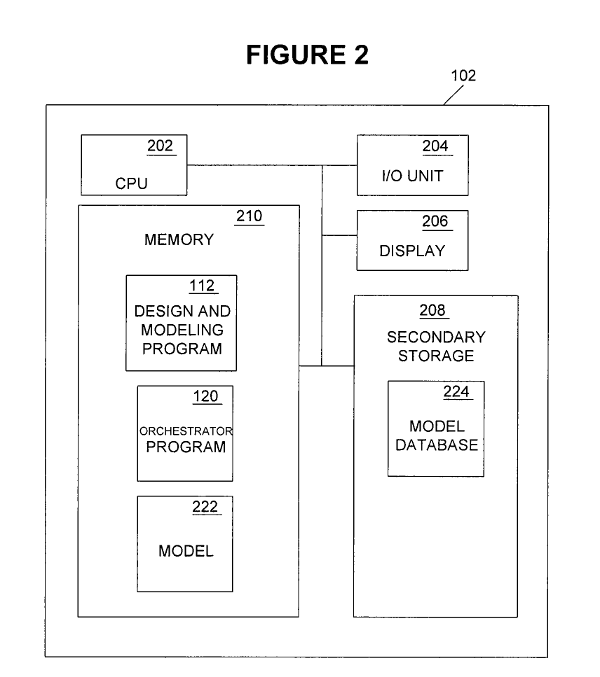

FIG. 2 shows a more detailed depiction of computer 102. Computer 102 comprises a central processing unit (CPU) 202, an input output I/O unit 204, a display device 206, a secondary storage device 208, and a memory 210. Computer 102 may further comprise standard input devices such as a keyboard, a mouse, a digitizer, or a speech processing means (each not illustrated).

Computer 102's memory 210 includes design and modeling program 112 for creating a building information model 222 and administrator/orchestrator program 120 for coordinating communication between the design and modeling program 112 and analysis programs 114, 116, and 118. The design and modeling program may be any suitable program for creating a building information model, such as Autodesk, Inc.'s Revit Architecture, Structures, and/or MEP Suite. Revit is a registered trademark of Autodesk, Inc. of San Rafael, Calif. Other product names written herein may be trademarks or registered trademarks of their respective owners. The building information model 222 is shown as being located in memory 210. However, the building information model 222 may also be stored in a model database 224 in a secondary storage device, such as secondary storage 208.

The building information model, which is also referred to as “building model” or “model” herein, comprises a three-dimensional representation of a building or part of a building as well as physical and/or informational characteristics of the building components. For example, the building information model for a house may tie a material type and cost to each component of the house, keep track of the three-dimensional relationships of the various components, and identify behavioral aspects of the components. In the illustrative example, the building information model is stored in the model database in a DXF format. However, the model may be stored in one or more different formats, such as IGES, STEP, IFC and the like.

Building information models and their creation is known to one having skill in the art and will not be described in more detail herein. See, e.g., L. Khemlani, The IFC Building Model: A Look Under the Hood, AECBytes, http://www.aecbytes.com/feature/2004/IFCmodel_pr.html, Mar. 30, 2004; IAI Modeling Support Group, IFC 2×Edition 2 Model Implementation Guide, v. 1.7, Mar. 18, 2004; and IAI Industry Foundation Classes IFC2× Edition 2 Addendum 1, http://www.iai-international.org/Model/R2×2_add1/index.html, 2004, which are incorporated herein by reference.

The administrator/orchestrator program will be described in more detail below. In the illustrative example, the administrator program is a stand-alone program that communicates with the design and modeling program and the analysis programs. In another embodiment, the administrator/orchestrator program may be a plug-in or component of another program, such as the design and modeling program.

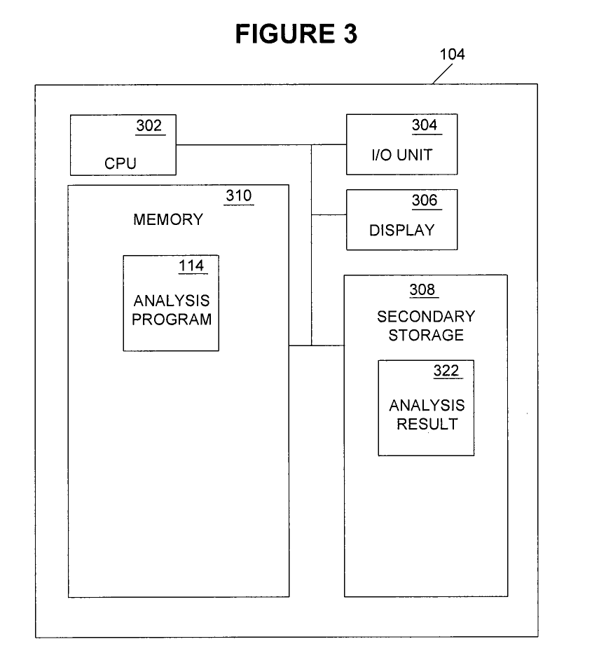

FIG. 3 shows a more detailed depiction of remote computer 104. Computers 106 and 108 may have similar configurations. Computer 104 comprises a central processing unit (CPU) 302, an input output I/O unit 304, a display device 306, a secondary storage device 308, and a memory 310. Computer 302 may further comprise standard input devices such as a keyboard, a mouse, a digitizer, or a speech processing means (each not illustrated).

Computer 104's memory 310 includes one or more analysis programs 114 for analyzing the building information model. The analysis program may be any suitable analysis program for analyzing the building information model or for performing a simulation based on the building information model. Each of the remote computers 104, 106, and 108 may include one or more analysis programs that perform different analyses, such as simulation of day light, lighting, energy use, wind effects, pedestrian circulation conditions, project scheduling, construction implementation, and the like. In the illustrative example, analysis program 114 is the SquareOne Ecotect with LBNL Radiance daylight simulation program, analysis program 116 is the ThermoAnalytics, Inc. RadTHERM energy simulation program, and analysis program 118 is the Anysys, Inc. Fluent wind effects simulation program. One having skill in the art will appreciate that these analysis programs are merely illustrative and that a different number of alternative analysis programs may be used. Analysis programs are known to one having skill in the art and will not be described in more detail herein. The analysis program performs an analysis may stores the analysis result 322, for example, in secondary storage.

For illustrative purposes, it will be assumed that the various programs described herein are operating in a Microsoft® Windows® operating system environment, however, one having skill in the art will appreciate that methods, systems, and articles of manufacture consistent with the present invention are not limited thereto. Also, the programs may comprise or may be included in one or more code sections containing instructions for performing their respective operations. While the programs are described as being implemented as software, the present implementation may be implemented as a combination of hardware and software or hardware alone.

Although aspects of methods, systems, and articles of manufacture consistent with the present invention are depicted as being stored in memory, one having skill in the art will appreciate that these aspects may be stored on or read from other computer-readable media, such as computer-readable storage media including secondary storage devices, like hard disks, floppy disks, CD-ROM, or other forms of ROM or RAM either currently known or later developed; or transmission media such as a carrier wave received from a network such as the Internet. Further, although specific components of data processing system 100 have been described, one having skill in the art will appreciate that a data processing system suitable for use with methods, systems, and articles of manufacture consistent with the present invention may contain additional or different components.

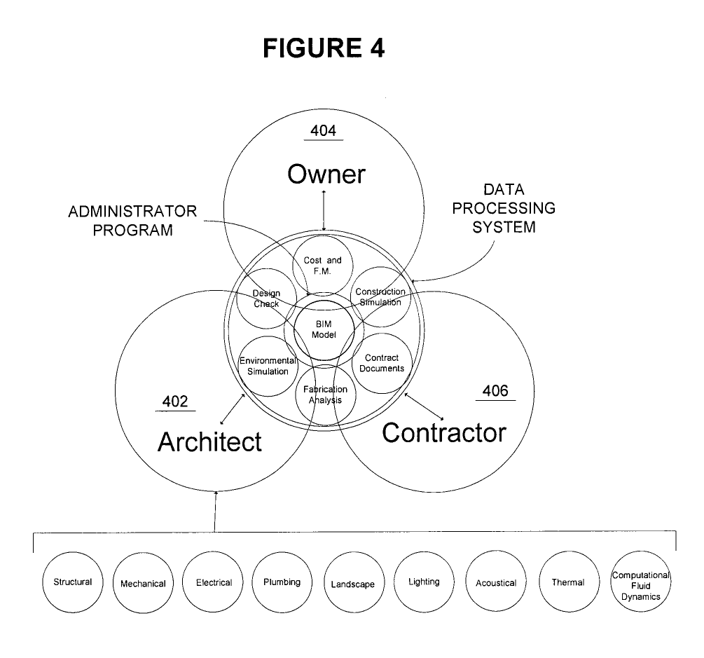

FIG. 4 depicts an illustrative context in which the data processing system may exist relative to potential users of the system. As shown, an architect 402, a building owner 404, and a contractor 406 may each play a role as user in contributing or viewing information. For example, the architect may design the building information model by entering structural, mechanical, electrical, plumbing, landscape, lighting, acoustical, thermal, and computational fluid dynamics information. The administrator/orchestrator program provides at least a part of the building information model to at least two of a plurality of analysis programs. In the illustrative example of FIG. 4, the analysis programs include an environmental simulator, a comparison to design intent, a cost analyzer, a construction simulator, a contract document management system, and a fabrication analyzer. The analysis programs return analysis results to the administrator program, which presents the results to the users. Further, the administrator program can forward analysis results that have been received from one analysis program to one or more of the other analysis programs, thereby allowing the other analysis programs to take this additional information into consideration when generating future results.

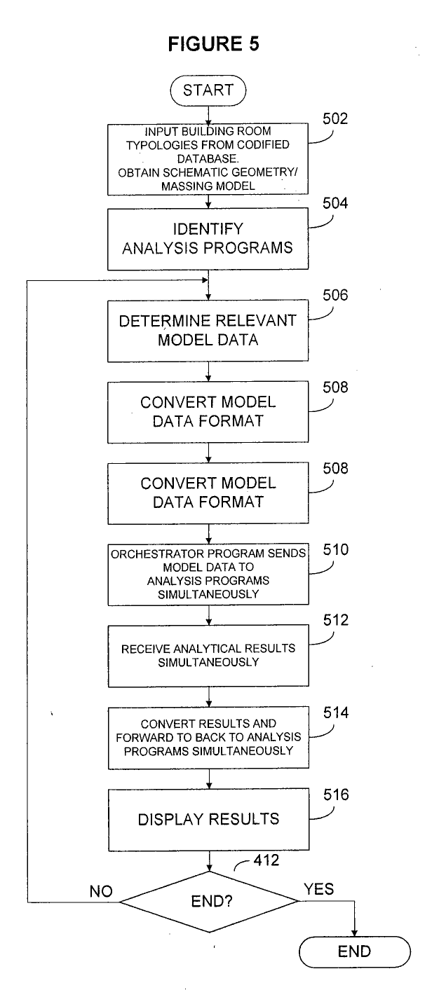

FIG. 5 depicts a flow diagram 500 illustrating exemplary steps performed by the administrator program for orchestrating information with the design and modeling program and the analysis programs. First, the administrator program obtains the building information model (step 502). This is done, for example, by periodically requesting the building information model from the design and modeling program. Alternatively, the administrator program may periodically read the building information model from the model database.

As described above, the building information model may be forwarded to a plurality of analysis programs. The administrator program identifies analysis programs to which to send model information by prompting the user to select the desired analysis programs (step 504). For example, the administrator program may display a drop-down list of available analysis programs from which the user may make one or more selections.

Then, the administrator program determines which model information to send to each of the selected analysis programs (step 506). Depending on the individual analysis program, some or all of the model information may be sent. For example, a daylight analysis program may require information about the three-dimensional structure and building material properties, such as window transparency. However, the daylight analysis program may not require building loading information and material cost data. The administrator/orchestrator program determines which information to send, for example, by identifying relevant datatypes in a lookup table. In another example, the administrator/orchestrator program may pass the building information model datatypes through a filter of required datatypes associated with each analysis program.

Industry-standardized file formats may reduce the need to the convert model information into a different format that is recognizable by the analysis programs. However, one or more of the analysis programs may not recognize the information format supported by the design and modeling program. To accommodate this case, the administrator/orchestrator program determines whether the model information is in a format that is compatible with each selected analysis program. This can be done, for example, by identifying compatible formats in a lookup table and the like.

If the model information is incompatible with one or more of the analysis programs, then the administrator/orchestrator program automatically converts the model information format into the proper formats (step 508). For example, if the design and modeling program outputs a model in the DXF format, but the analysis program 114 only recognizes the IGES format, then the administrator program converts the model information from the DXF format to the IGES format. This can be done for example, using format conversion techniques or plug-ins, which are known in the art. After the required model information has been identified and converted, if necessary, then the administrator/orchestrator program sends the model information to the selected analysis programs (step 510).

After receiving the model information, each selected analysis program performs a respective analysis or simulation and outputs an analysis result. As the administrator/orchestrator program automatically sends the model information to the various analysis programs simultaneously or within a short time period, the analysis programs perform their respective analyses simultaneously. This is unlike conventional approaches, in which model data is manually sent to one simulator at a time. In the illustrative example of FIG. 1, the user has selected analysis programs 114, 116, and 118. Therefore, upon receiving the relevant model information, analysis program 114 performs a daylight simulation, analysis program 116 performs an energy simulation, and analysis program 118 performs a wind effects simulation. Each of these analysis programs then automatically provides an analysis result.

The administrator/orchestrator program automatically obtains the analysis result from each analysis program, for example, by polling for the results (step 512). The results may be obtained by a different mechanism, such as by periodically reading a respective analysis result file from a secondary storage device that is associated with the analysis program computer.

To enhance the results of the various analysis programs, the administrator/orchestrator program may forward analysis results from one or more of the analysis programs to one or more other analysis programs (step 514). These results can be transmitted separately from the model information or included at the time the model information is sent by the administrator program. For example, a building energy analysis program may receive as input room sunlight characteristics from a daylight analysis program, thereby providing more accurate time-variant modeling. If the data format from one or more of the analysis programs needs to be converted to a different format prior to transfer to another analysis program, then the administrator/orchestrator program automatically performs the conversion. This can be done for example, using format conversion techniques or plug-ins, which are known in the art.

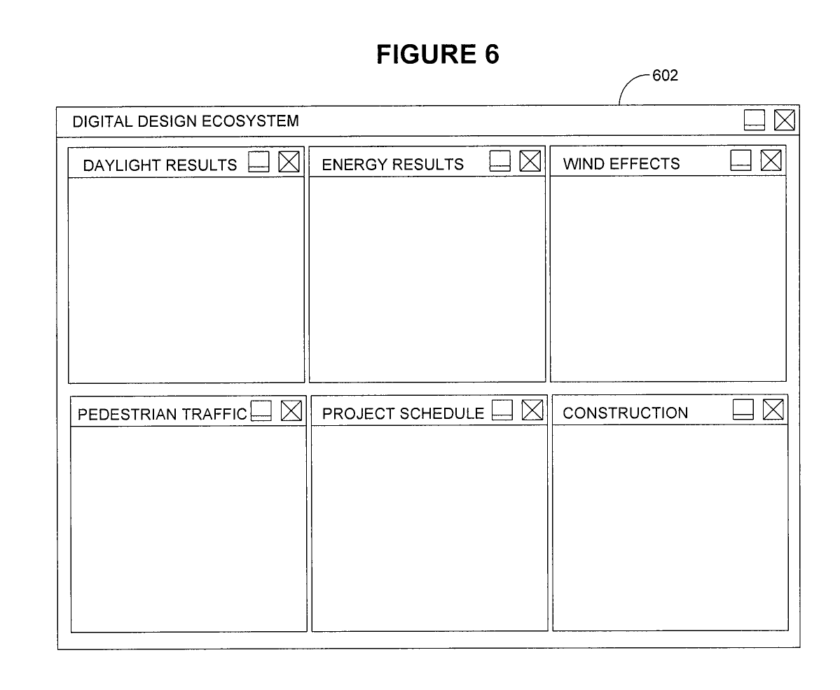

The administrator/orchestrator program displays the analysis results from the various selected analysis programs on the display device (step 516). In the preferred embodiment, the various analysis results may be displayed simultaneously on the same display device, for example in an array of boxes or windows on the screen, as shown in illustrative screenshot 602 of FIG. 6. The display device may be the same display device that presents the building information model or another display device. Alternatively, the results from the different analysis programs may be displayed on more than one display device, such as multiple video displays connected to computer 102.

By displaying the building information model on a first display device and displaying the analysis results on a different display device or in a separate area of the first display device's video screen, the user can view in real-time the effects that the design changes to the model have on the various analysis results. For example, if the user adds a new window to the building model, the system may automatically display updated daylight, energy, and wind effects results. Therefore, the user is able to see, in real-time, all relevant effects of design changes. This may influence the user's design choices and allow the user to quickly modify the design, and then view the automatically-displayed new analysis results in real-time. This can greatly shorten the design cycle and provide more accurate designs compared to conventional approaches that perform analyses serially, which does not allow the user to see a holistic view of all analyses simultaneously, and after a model has been created.

If the user determines that no additional analysis results are needed, then the user enters an input to stop receiving analysis results (step 518). Otherwise, program flow returns to step 506 to continue real-time analysis of model information.

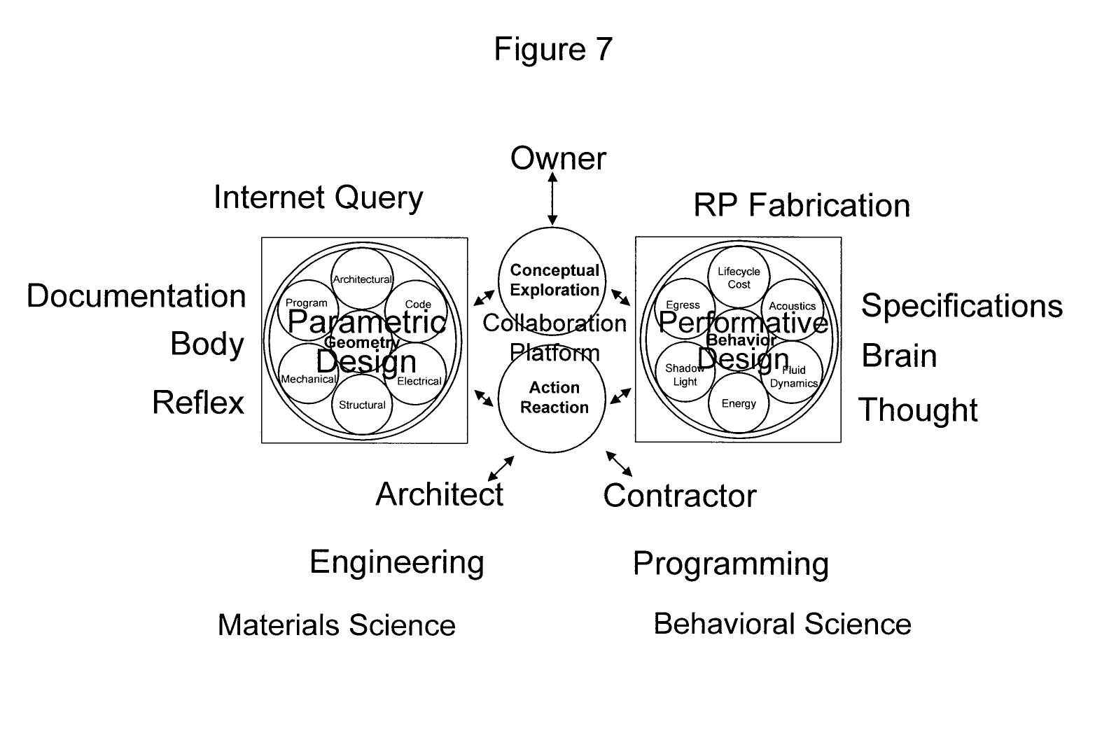

Thus, the data processing system consistent with the present invention provides an administrator/orchestrator program that simultaneously sends model information to a plurality of analysis programs and displays the analysis programs' results in real-time. Further, the administrator/orchestrator program may pass information between the various analysis programs. As shown in FIG. 7, this bridges the gap between parametric design and performative design. Architect, owner, and/or contractor can work with a holistic view of the building system, making changes and viewing their effects in real-time.

The foregoing description of an implementation of the invention has been presented for purposes of illustration and description. It is not exhaustive and does not limit the invention to the precise form disclosed. Modifications and variations are possible in light of the above teachings or may be acquired from practicing the invention. For example, the described implementation includes software but the present implementation may be implemented as a combination of hardware and software or hardware alone. The invention may be implemented with both object-oriented and non-object-oriented programming systems. The scope of the invention is defined by the claims and their equivalents.

What is claimed:

1. A method in a data processing system having an administrator/orchestrator program and a plurality of analysis programs, the method comprising the steps performed by the administrator/orchestrator program of:
obtaining a building information model;
outputting a copy of at least a part of the building information model to at least two of the analysis programs;
receiving an analysis result, which is based on an analysis of the copy of the at least part of the building information model, from each of the at least two analysis programs, the at least two analysis programs performing a respective analysis simultaneously to each other; and
simultaneously displaying at least two of the received analysis results, such that effects in the received analysis results are simultaneously displayed in real-time responsive to changes in the building model.

2. The method of claim 1, further comprising the step of:
outputting at least a part of an analysis result received from one of the analysis programs to different one of the analysis programs.

3. The method of claim 2, further comprising the step of:
converting the analysis result to a different format prior to outputting the at least a part of the analysis result to the different one of the analysis programs.

4. The method of claim 1, further comprising the step of:
converting the building information model to a different format.

5. The method of claim 1, wherein each of the analysis programs performs one or more analysis of day light, lighting, energy use, wind effects, pedestrian circulation conditions, project scheduling, and construction implementation.

6. The method of claim 1, wherein the data processing system comprises a plurality of computer system, at least one of the analysis programs residing on a different computer system than the administrator/orchestrator program.

7. The method of claim 1, wherein the at least two received analysis results are displayed simultaneously on a same display device.

8. A computer-readable storage medium containing instructions that cause an administrator/orchestrator program, in a data processing system having the administrator/orchestrator program and a plurality of analysis programs, to perform a method comprising the steps of:
obtaining a building information model;
outputting a copy of at least a part of the building information model to at least two of the analysis programs;
receiving an analysis result, which is based on an analysis of the copy of the at least part of the building information model, from each of the at least two analysis programs, the at least two analysis programs performing a respective analysis simultaneously to each other; and
simultaneously displaying at least two of the received analysis results, such that effects in the received analysis results are simultaneously displayed in real-time responsive to changes in the building model.

9. The computer-readable storage medium of claim 8, further comprising the step of:
outputting at least a part of an analysis result received from one of the analysis programs to different one of the analysis programs.

10. The computer-readable storage medium of claim 9, further comprising the step of:
converting the analysis result to a different format prior to outputting the at least a part of the analysis result to the different one of the analysis programs.

11. The computer-readable storage medium of claim 8, further comprising the step of:
converting the building information model to a different format.

12. The computer-readable storage medium of claim 8, wherein each of the analysis programs performs one or more analysis of day light, lighting, energy use, wind effects, pedestrian circulation conditions, project scheduling, and construction implementation.

13. The computer-readable storage medium of claim 8, wherein the data processing system comprises a plurality of computer system, at least one of the analysis programs residing on a different computer system than the administrator/orchestrator program.

14. The computer-readable storage medium of claim 8, wherein the at least two received analysis results are displayed simultaneously on a same display device.

15. A data processing system comprising:
a memory comprising an administrator/orchestrator program that
obtains a building information model,
outputs a copy of at least a part of the building information model to at least two of a plurality of analysis programs,
receives an analysis result, which is based on an analysis of the copy of the at least part of the building information model, from each of the at least two analysis programs, the at least two analysis programs performing a respective analysis simultaneously to each other, and
simultaneously displays at least two of the received analysis results, such that effects in the received analysis results are simultaneously displayed in real-time responsive to changes in the building model; and
a processing unit that runs the administrator program.

16. A data processing system comprising:
means for obtaining a building information model;
means for outputting a copy of at least a part of the building information model to at least two of a plurality of analysis programs;
means for receiving an analysis result, which is based on an analysis of the copy of the at least part of the building information model, from each of the at least two analysis programs, the at least two analysis programs performing a respective analysis simultaneously to each other; and
means for simultaneously displaying at least two of the received analysis results, such that effects in the received analysis results are simultaneously displayed in real-time responsive to changes in the building model.
